(19) United States
(12) Patent Application Publication
(10) Pub. No.: US 2003/0089254 A1
(43) Pub. Date: May 15, 2003

(54) Method and devices for adjusting a roller in a printing machine

(76) Inventors: Wolfgang Otto Reder, Veitshochheim (DE); Georg Schneider, Wurzburg (DE)

Correspondence Address: Douglas R Hanscom, Jones Tullar & Cooper, Eads Station, PO Box 2266, Arlington, VA, 22202, US

(21) Appl. No.: 10/168,531

(22) PCT Filed: Dec. 16, 2000
(86) PCT No.: PCT/DE00/04503

(30) Foreign Application Priority Data
Dec. 31, 1999 (DE) 199-63-944.2

(51) Int. Cl. B41F 13/24

(52) U.S. Cl. 101/248

(57) ABSTRACT

The invention relates to an adjustable bearing arrangement for remote-controlled adjustment of an inking roller or a dampening roller in relation to another roller. This is achieved by fixing the axes or journals of the roller which is to be adjusted to a receiving element for said axes or journals and by transferring a pre-settable adjusting force from one roller to the other roller. In the adjustment position, the receiving elements of the axes or journals are locked in such a way that it is temporarily impossible for the roller thus adjusted to move in the direction of adjustment or in a direction opposite thereto.

The invention relates to a method and devices for adjusting a roller in accordance with the preambles of claims 1, 6 or 13.

A device for adjusting a roller of an inking or dampening unit of a printing press in relation to an adjoining roller has become known from EP 0 826 501 A1.

DE 199 19 733 A1 discloses a device for setting the contact pressure between two rollers of a printing press, wherein a spring force is applied to a first roller and it is fixed in place on a frame by means of an arresting device.

DE 197 19 305 A1 discloses a bearing arrangement for a roller of an inking or dampening unit, whose roller holder can be positioned by means of a spring and can be fixed in place by means of being clamped.

DE 42 32 163 C1 describes a device for maintaining a set positioning pressure of an inking roller by means of a temperature-dependent actuator.

The object of the invention is based on creating a method and devices for adjusting a roller of a printing press.

In accordance with the invention, this object is attained by means of the characteristics of claims 1, 6 or 13.

The advantages which can be gained by means of the invention consist in particular in the compact construction of the device. In this case the diameter of each device is equal to or preferably less than the diameter of the cylindrical shell of the roller of the inking or dampening unit. For this reason no hindrance between these devices need to be feared when several such devices are used next to each other, for example at two adjoining inking rollers with a riding roller placed thereupon as the third roller—wherein all rollers are adjustable.

A preselectable positioning pressure of the inking or dampening unit roller is made dependably possible by means of a preselectable force generated, for example, by an operating device for linear movement—such as, for example, a motor for linear movements (a cylinder with a piston); piezo-operating devices, electrochemical operating devices, etc.—gaseous or liquid media, or electrical current. This adjustment is reproducible, i.e. flattening of a rubber covering of a dampening or inking roller (roller strip). This means that the so-called “inking or dampening roller strips” can be kept at a constant width (flattening of a rubber covering of a dampening or inking roller).

It is not possible to affect a so-called “channel beat” when the inking or dampening roller rolls over a gap on other rollers, because the fixing pressure P_{F}, and therefore the fixing force F_{F}, with which the roller journal of the inking or dampening roller is held in a fixed manner, can only be set to be larger by a multiple of the positioning pressure P_{A}, and therefore the positioning force F_{A}, with which the covering of the roller is pressed against the shell of an immediately adjoining cylinder or roller.

A rapid pre-adjustment of the rollers, also for compensating changes in diameter in the course of production, and/or in case of changes in the Shore hardness of the rollers, is possible. Because of this the set-up times become practically negligibly small. It is also possible to adjust them remotely, for example centrally from a press control console.

The receiver of the roller(s) can be maintained “locked in” during the entire running time. A high degree of quiet running of the rollers is assured by this even when the printing press is running, because the “swing-up” of vibrations at the roller journals/-shafts is not possible because of the application of a clamping effect (blocking effect). By acting on the distributing cylinder with a fixing pressure P_{F}, or a fixing force F_{F}, which is/are greater by a multiple than the positioning pressure P_{A}, or the positioning force F_{A}, it is achieved that a detent which follows the performed positioning is pressed against a counter-bearing fixed in place on the frame so strongly that, with the prevailing operational state of the roller positioning, an unintentional movement of the positioned roller in or opposite the roller positioning direction E is impossible.

An exemplary embodiment of the invention is represented in the drawings and will be described in greater detail in what follows. Shown are in:

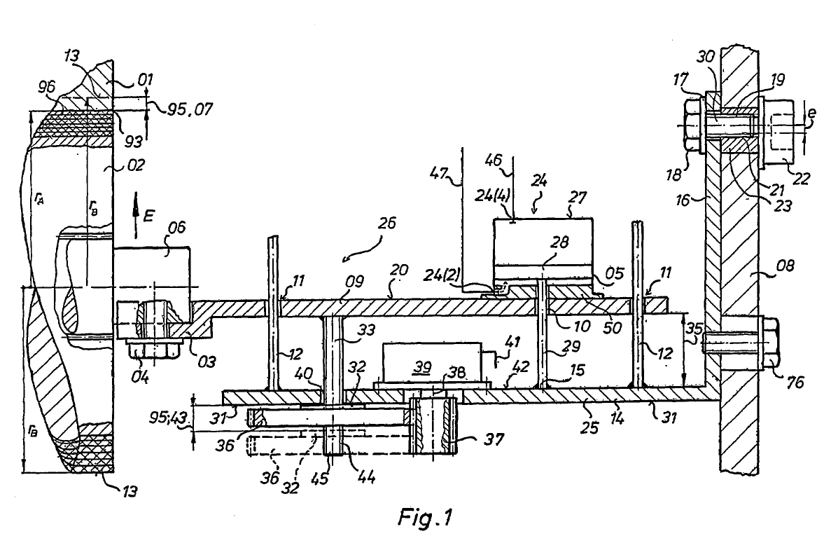

FIG. 1, a lateral view in the positioning position, with the clamping opened (principal representation), on the ends of two adjoining rollers, whose first roller can be moved to position the second roller by means of the device in accordance with the invention,

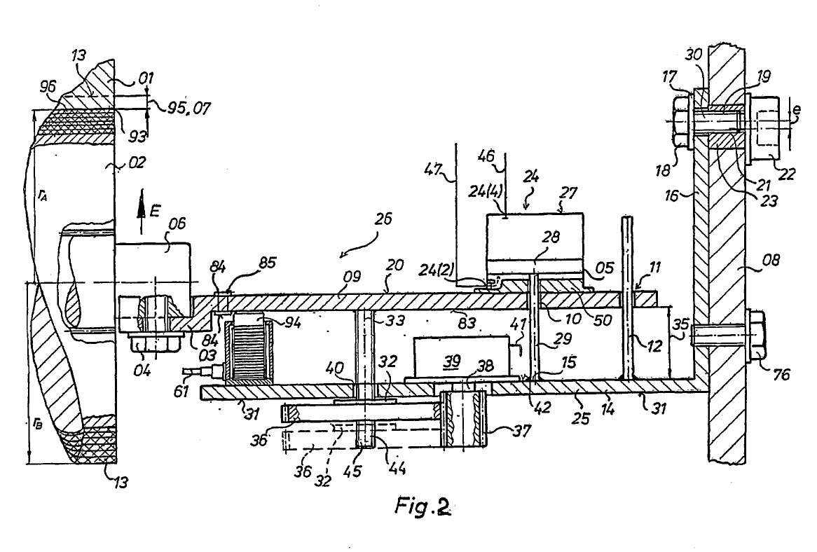

FIG. 2, a further embodiment of the device in accordance with FIG. 1,

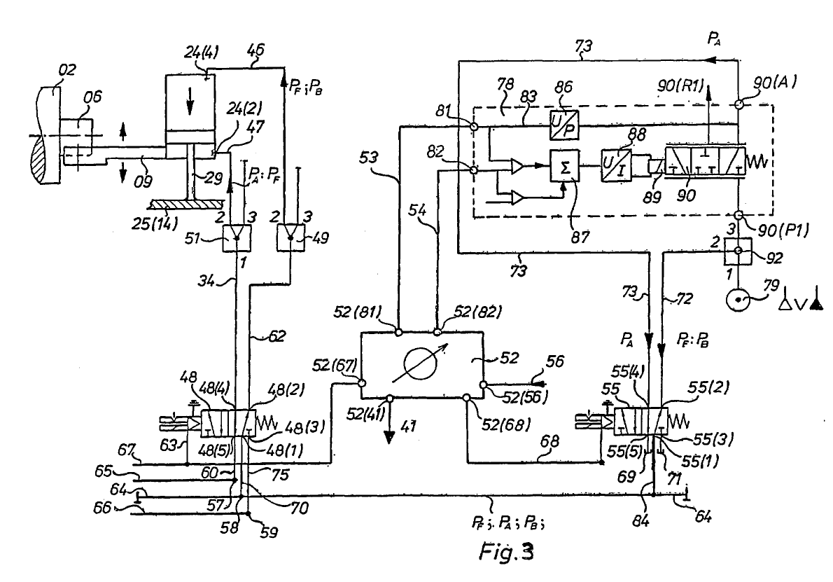

FIG. 3, a pneumatic switching diagram for controlling the device in FIGS. 1 and 2.

A first roller or cylinder 01 of an inking or print unit of a printing press is seated pivotably or fixedly in lateral frames.

Against it a second roller 02 having a shell 05 of a flexible (rubber-elastic or elastomeric) plastic material, for example rubber or other rubber-like material, can be placed by means of a movable, for example shell-shaped journal receiver 03 or shaft receiver (called “receiver” for short in what follows).

The roller 02 is rotatably seated at both ends on respective bearing shafts 06 by means of friction or rolling bearings. Each bearing shaft 06 is fastened, fixed against relative rotation, on a journal receiver 03, for example by means of a screw 04. This is accomplished by turning the screw 04 through a bore in the journal receiver 03 into a threaded bore in the journal 06. Instead of seating on shafts 06, it is of course also possible to provide the seating by means of journals 06 attached by material-to-material contact to the roller 02. However, it would then be necessary to arrange bearings on the receiver 03.

The bearing journals 06 of the roller 02 are fastened in the shell-shaped journal receivers 03 which are assigned to each.

The journal receiver 03 is fastened on a set plate 09 (for example welded to it). The latter has a plurality of guide bores 11. In addition, a drive mechanism 24 (operating device) is provided on it, which is fastened to it by means of a housing 05.

The drive mechanism 24 (operating device 04) can be designed as a motor for rotary movements—such as an electric, pneumatic or hydraulic motor, for example—, but also as a motor for linear movements—such as a work cylinder with a piston, a linear motor, a d.c. magnet, a piezo-operating device, an electrochemical operating device, for example—.

In this connection it is important that torque, power or output of the operating device 24 can be adjusted.

In the exemplary embodiment the drive mechanism 24 is designed as a motor for linear movement. A double-acting work cylinder 27 is used for this, on which a gaseous or liquid medium (for example air or oil) can act. The housing 05 of the drive mechanism 24 (operating device), for example a work cylinder 27, is fastened on a top surface 20 of the set plate 09 with its piston rod side 50 pointing downward.

A piston rod 29 of a piston 28 of the work cylinder 27 projects downward through a bore 10 of the plate 09. Its end 15 is rigidly or flexibly fastened on a horizontal leg 25 (=base plate 25) of a support elbow 14.

A vertical leg 16, i.e. a base plate 25, of the support elbow 14 can be respectively adjusted in and opposite to the vertical direction and can be fixed in place on the inside of a machine frame 08 of a print unit or ink unit.

The device, called “device for adjustment 26” as a whole, can also be arranged inside an opening (bore) in the lateral frame 08 and can be supported thereon.

An eccentric bushing 23, which is seated in the machine frame 08 so it can be rotated and fixed in place and has an eccentricity “e”, is used for the vertical adjustment of the device 26. The eccentric bushing 23 has a hexagonal adjustment head 22 seated on the exterior, by means of which a rotating movement can be introduced into the eccentric bushing 23 by means of a wrench.

A device for arresting 17 of the eccentric bushing 23 is furthermore provided. It can consist, for example, of a ratchet screw 18 with a smooth shaft 30 and a threaded part 19. The threaded part 19 is in engagement with an interior screw thread 21 of a bore of the eccentric device 23. The ratchet screw 18 can be tightened so securely that the set position of the leg 16, and therefore the position of the device 26 can no longer be changed. The (fastening) leg 16 has been threaded on the shaft 30 by its bore which is matched to the diameter of the shaft 30. It is possible to provide a ratchet screw 76 for additional securing, which is screwed through a slit in the machine frame 08 into a threaded bore in the (fastening) leg 16 resting against the lateral frame 08. By means of this it is possible to securely press the leg 16 against the inner surface of the machine frame 08.

A plurality of vertically oriented guide rods 12 are fastened, for example welded, to a top side 42 of the base plate 25. The guide rods 12 have the job of making possible, in cooperation with tightly matched guide bores 11 on the set plate 09 along the guide rods 12 and in this way to achieve a change in the distance 35 between the base plate 25 and the set plate 09.

An upper end of a rod 33, which is downward oriented at right angles and has an exterior screw thread 44, is welded to the underside of the set plate 09. Its lower free end 45 extends freely downward, for example by 20 mm, through a bore 40 in the base plate 26 (=mounting leg) of the support elbow 14.

A detent 32, for example in the shape of a disk, has been threaded on the free end 46 of the rod 33. The distance of this detent 32 can be adjusted in relation to the underside 31 of the base plate 25 along the rod 33, for example a threaded rod. This can take place, as represented in the exemplary embodiment, for example, by designing the detent 32 as a driveable adjusting nut 32, which can be turned in a clockwise and counterclockwise direction on the screw thread of the free end 45 of the rod 33.

However, other solutions would also be conceivable. Instead of moving the detent 32 along the free end 45, the detent 32 can also be fastened, fixed against relative rotation, on the free end 45 of the rod 33, and the rod 33 can be arranged so that it can be moved back and forth and fixed in place. For example, this could take place in such a way that the rod 33 is provided with an exterior screw thread 44, which is in engagement with a screw thread in a bore in the set plate 09. An end of the rod 33 which extends at the top above the set plate 09 is connected with a drive mechanism which can be changed from running toward the right to running toward the left, for example an electric motor or a pneumatic motor, for example a step motor, but the use of a servo valve would also be conceivable.

The detent 32 is driven by using a disk-shaped detent 32 (FIG. 1), which can be moved back and forth along the free end 45 of the (threaded) rod 33 via a threaded connection.

To this end the detent 32 itself is provided, for example, with a first gear rim 36 or a gear wheel 36. The teeth of the gear rim, or the gear wheel 36 are in engagement with teeth of a driving gear wheel 37 which, the same as the detent 32, is arranged underneath the base plate 25. The width of the tooth face of the driving gear wheel 37 is a multiple of the width of the tooth faces of the teeth of the gear rim 36.

It is achieved by means of this that the detent 32, embodied as a hub with the gear rim, or as a part gear wheel 36 of the gear wheel 36, can be moved along a predefined adjustment length without the engagement of the teeth of the gear wheel 36 and the driving gear wheel 37 being lost.

The driving gear wheel 37 is connected, fixed against relative rotation, with a drive mechanism 39 (operating device), whose direction of rotation can be reversed, for example a motor for rotary movements (electric, step, hydraulic, pneumatic motor) via the driveshaft 38 of the latter.

Depending on the design, the drive mechanism 39 is fastened, for example, on the top 42 of the base plate 25—i.e. in the space between the set plate 09 and the base plate 25—of the base plate 25, or on its underside 31. The driveshaft 38 with the driving gear wheel 39 projects downward through a bore in the base plate 25.

In the exemplary embodiment in accordance with FIG. 1, the detent 32—in this case as a hub of the gear wheel 36, can be rotated by the driving gear wheel 37. Depending on the direction of rotation of the gear wheel 36, and therefore of the adjusting nut 32, it moves along the screw thread 44 of the rod 32 toward the underside of the base plate 25 or away from it. It can be stopped and fixed in place on the rod 33 at any distance from the underside 31, but can also be stopped when touching the underside 31.

Depending on the arrangement, the detent 32 can be supported not only on the base plate 25, but also on the set plate 09.

A practically step-free pressing—as a function of the pressure force F_{A} introduced into the receiver 09—of two immediately adjoining rollers 01 and 02 against each other is possible with the method and the devices in accordance with FIGS. 1 and 2. In this case the roller 02 which is to be placed against the other—and therefore the receiver 06—travels at least a positioning length to a final placement 69 of the roller 02. The indentation depth 07 in the for example highly elastic, or rubber-elastic or elastomeric shell 13 of one of the two rollers 01, 02, or the width of the so-called roller strip of the rollers 01, 02 placed against each other, is a measure of the pressure, which is a function of the pressure force. At least one of the two rollers 01, 02 must have a rubber-elastic or highly elastic or elastomeric cover (shell 13).

To adjust the positioning pressure between the two rollers 01, 02, at least one of the two rollers 01, 02 must be arranged so it can be placed against or away from the other roller 02, 02, i.e. it must be able to perform a lift 95 which is greater than the maximally attainable depth of the indentation into the shell 13 (least positioning length). With rollers 02 and 01 pressed against each other, the shell 13 between them is compressed by the amount (Γ_{B}−Γ_{A}), equals the indentation depth 07, and results in the partially indented shell 96.

The positioning of the roller 02 takes place via its two bearing shafts 06 (only one represented). However, an over-mounted seating would also be possible, so that there would only be one bearing shaft, or bearing journal 06, per roller 02.

For this reason one device for adjusting 26 an inking or dampening unit roller 01, 02 per bearing shaft 06, each with one journal receiver 03 with an available lift 95 and a presettable positioning force F_{A} and fixing force F_{F}, is advantageous.

The limit of the lift 95 of the roller 02 to be adjusted can be set in a step-free manner. This takes place by the change of position of the detent 32 on the rod 33 in the direction of the longitudinal axis. Or, differently expressed, the position of the detent 32 of the set plate 09 in relation to the base plate 25, which is fixed on the frame, can be adjusted and set.

Before the roller 02 can be placed against the roller 01 with a preselected positioning pressure P_{A}, or positioning force F_{A}, the detent 32 (adjusting nut) must be placed a sufficiently large distance 43 away from a stop face 31 fixed on the frame—in this case the underside 31 of the base plate 25—(see the gear wheel 36 and detent 32 shown in dashed lines in FIG. 1). To do this, the gear wheel 36 with the detent 32 is rotatingly driven by the drive mechanism 39, 37 in such a way that it has been moved along the screw thread 44 of the rod 33 from the stop face 31 to a preselectable distance 43, which in this case would correspond to the maximally achievable lift 95.

In the course of the just described process or after its termination, the drive mechanism 24 moves the set plate 09 with the journal receiver 03 at a preset positioning force F_{A} away from the base plate 25, which is fixed in place in the machine frame and is directly or indirectly supported in the machine frame. The roller 02 with its, for example, rubber-elastic shell 13 of course also follows this movement in the direction toward the roller 01. The roller 02 with the shell 13 is moved, resting against the shell of the roller 01, with a preset positioning force F_{A} until it is at equilibrium with the reaction force (positioning as a function of the positioning force).

Thereafter the gear wheel 36 is driven and thereby the detent 32 moved in the opposite direction of rotation until at the end it comes into contact by means of a torque, or force, which can be preset by means of the drive mechanism 39, and is slightly tightened. The drive mechanism 39 is immediately stopped and the positioning pressure P_{A}, or the positioning force F_{A}, is increased by a multiple of F_{A} (for example four times) by means of the drive mechanism 24, and in this way a preset fixing force F_{F}, or fixing pressure P_{F}, is achieved. The detent 32 is pressed, or pulled, even more strongly against the stop face 31 by means of the increased fixing force F_{F}, because the drive mechanism 24 acts in a manner in which the set plate 09 and the base plate 25 are moved away from each other. In this operational position a change of the shaft distances at the rollers 01 and 02 in the direction toward the roller 01 is practically no longer possible. Thus, the ability of the receiver 06 to move is blocked.

In the course of a new setting of the positioning force F_{A}, or when moving the roller 02 away from the roller 01, the positioning pressure/force P_{A}/F_{A} is set to zero. Thereafter, or simultaneously, the detent 32 is brought into a preselectable distance 45 from the stop face 31 by means of the gear wheel 36, which is now moved backwards by the drive mechanism 39 and is stopped; the positioning pressure/force P_{A}/F_{A}, or the fixing pressure/force F_{P}/F_{F}, are reversed in their direction. Through this step, the detent 32 achieves in the end a sufficient distance 43 from the stop face 31, and the roller 02 is moved away from the roller 01.

Another adjustment possibility would be the “distancedependent” positioning. For this, the detent 32 is initially brought into a preselected distance 43 in respect to the stop face 31.

Thereafter, the set plate 09 with the threaded rod 37, the detent 32 and the gear wheel 36 are moved by means of the drive mechanism 24 at a preset force, for example fixing pressure/force F_{P}/F_{F}, away from the base plate 25 fixed in the frame until in the end the detent 32 comes into contact with the stop face 31. This fixing pressure/force F_{P}/F_{F} is applied during the entire operating time. If the roller 02 is to be moved away, the direction of the fixing pressure, or of the fixing force, is reversed and the set plate 09 is pulled in the direction toward the base plate 25.

However, a version is also possible, in accordance with which the detent 32 is fastened in a movable and arrestable manner on parts—for example the guide rod 12—of the base plate, namely between the set plate 09 and the base plate 25, or on a free end of the guide rod 12 passed through the guide bore 11.

While the position of the detent 32 can be adjusted by means of the drive mechanism 39 (operating device), the drive mechanism 24 (operating device) is provided for moving the set plate 09. In the exemplary embodiment, the drive mechanism 24 is embodied, for example, as a double-acting pneumatic or hydraulic cylinder 24 (servo cylinder 24) with the piston chamber connector 24(4) and the piston rod chamber connector 24(2).

The connector 24(2) is connected by means of a pneumatic, or hydraulic line 47 with a first branch connector 51(2) of a first pneumatic, or hydraulic distributor 51. A second branch connector 51(3) is either connected with a piston rod chamber connector of a further servo cylinder, or it is closed.

A feed connector 51(1) of the first distributor 51 is connected by means of a pneumatic, or hydraulic line 34 with a connector 48(4) of a first 5/2-way directional control valve 48, which is used as the “pressure” or “positioning” valve. A connector 48(5) of the directional control valve 48 is connected via a pneumatic, or hydraulic intermediate line 60 with a first exhaust line 65 via a connector 57.

The piston chamber connector 24(4) of the servo cylinder 24 is connected by means of a pneumatic, or hydraulic line 62 with a first branch connector 49(2) of a second pneumatic, or hydraulic distributor 49. A second branch connector 49(3) is either connected with a piston chamber connector of a further servo cylinder, or it is closed.

A feed connector 49(1) of the second distributor 49 is connected with a connector 48(2) of the 5/2-way directional control valve 48 by means of a pneumatic, or hydraulic line 46. A connector 48(1) of the 5/2-way directional control valve 48 is connected by means of a pneumatic, or hydraulic line 70 via a connector 58 of a second pneumatic, or hydraulic pressure feed line 64 (pipeline or hose).

A first (admission) connector 48(3) is connected by means of a pneumatic, or hydraulic line 75 (pipeline or hose) via a connector 59 with a second exhaust line 66 (pipeline or hose).

An electro-pneumatic, or electro-hydraulic pressure control valve 78, called “E/P pressure control valve” for short in what follows, is provided for supplying the pneumatic (or hydraulic) cylinders 24 with compressed air, or a pressure medium, for generating the positioning pressure P_{A}. In accordance with an analog electrical reference variable, which can be remotely adjusted, this E/P pressure control valve 78 selects a pressure P_{A}, which for example is proportional to the reference variable.

The integrated electronic device of the E/P pressure control valve 78 performs a comparison between the set positioning pressure reference variable and the actual positioning pressure P_{A} in the work line 73 (actual pressure value), which is detected by means of a piezo-resistive pressure sensor 86.

A regulator 87 generates a manipulated variable, with which a 3/3-way directional control valve 90 is controlled via a clocked U/I converter 88 and a proportional magnet 89, so that the preset “positioning pressure” P_{A} is available at the connector 90(A) of the 3/3-way directional control valve. The work line 73 (pipeline or hose) is connected with its first end to the connector 90(A) of the directional control valve 90.

A second end of the work line 73 (pipeline or hose) is connected to a connector 55(4) of a second 5/2-way directional control valve 55.

From a fluid pressure source 79 and via an input 92(1) of a distributor 92, a gaseous or liquid fluid (air or hydraulic fluid) charged with an operating positioning pressure P_{B}, which can be the fixing pressure P_{F} at the same time (for example 6 to 12 bar), reaches a connector 90(P1) of the 3/3-way directional control valve 90 of the electro-pneumatic (or hydraulic) pressure control valve 78 through a first outlet 92(3) of the distributor 92. A second outlet 92(2) of the distributor 92 is connected via a work line 72 (pipeline or hose) with a connector 55(2) of the second 5/2-way directional control valve 55 (having two flow-through positions connectors, two switching positions, actuation by means of a proportional magnet and restoring spring and lock-in position).

A connector 55(1) of the second 5/2-way directional control valve 55 is connected via an intermediate line 84 to the pressure feed line 64. The connectors 55(5) and 55(1) of the directional control valve 55 are closed by means of closures 69 and 71.

In the first switching position, the “fixing position” (represented in FIG. 2) of the second directional control valve 55 a higher pressure, the “fixing pressure” P_{F}, for example the positioning operating pressure of 10 bar, is present at the connector 48(1). In the second switching position, the “positioning position”, of the second directional control valve 55, the “positioning pressure Pₐ”, is present at the connector 48(1). As a rule, this is lower than the “fixing pressure P_{F}”. The “positioning pressure Pₐ” can be regulated and kept constant at, for example, 0.1 to 8.0 bar, by means of the pressure control valve 78.

In a first position, the “fixing position” of the 5/2-way directional control valve 55, a flow connection is made between the connectors 55(2) and 55(1).

Thus, the higher “fixing pressure P_{F}” now prevails in the feed line 64.

In a second position, the “positioning position” of the second 5/2-way directional control valve 55, a flow connection is provided between the connectors 55(4) and the connector 55(1). Thus, the lower “positioning pressure Pₐ” now prevails in the feed line 64.

The directional control valve 48 also has two positions. A second position, the so-called “positioning position”, and the first position, the so-called “moved-away position” (represented in FIG. 2).

The connectors 48(4) and 48(1) of the directional control valve 48 are switched to flow-through in the “positioning position”; the connectors 48(2) and 48(3) also. In that case the piston rod chamber of the servo cylinder 24 is then charged, depending on the switching position of the directional control valve 55, either with the lower positioning pressure P_{A}, or the higher fixing pressure P_{F}, over the path 24(2), 47, 52(2), 51(1), 34, 48(4), 48(1) and the feed line 64.

In this case the piston chamber of the servo cylinder 24 is vented via 24(4), 46, 49(2), 49(1), 62, 48(2), 48(3) and the exhaust line 66.

In the “positioning position” it is achieved that via the set plate 09 the roller 02 is pressed against a second roller 01 with a pressure P_{A}—for example 2 bar—, which can be preselected and kept constant. In the course of this a flattening, or measurable width, or indentation depth 07, of the, or in the cover of the elastomeric shell 13 of the cylinder 02 is achieved. This can be changed, i.e. set, as a function of the charged pressure P_{A}.

In the “moved-away position” the roller 02 is moved away from the roller 01. In this case the second directional control valve 55 has been switched in such a way—flow-through between the connectors 55(2) and 55(10—that the high operating pressure P_{B}, which can be equal to the fixing pressure P_{F}, is present in the feed line 64.

The directional control valve 48 is in the “moved-away position” (represented in FIG. 2). The connectors 48(2) and 48(1) on the one hand, and the connectors 48(4) and 48(6) on the other hand, have been switched to flow-through. It follows from this, that the full pressure P_{F}, or P_{B}, prevails in the piston chamber of the cylinder 24, and the set plate 09 with the cylinder 02 fastened thereon is moved away from the cylinder 01 for a predetermined distance. Venting is performed via the connectors 48(4) and 48(5) over the line 60 and the first exhaust line 65. At the end of this process the cylinder 01 is in the “rollers off position”.

All drive mechanisms and operating devices, such as the drive mechanisms 24, 39 and also 94, can be controlled from a central machine control console via a central electronic control device 52 (for example a computer). Moreover, the reference variables for the presettable pressures P_{A} and P_{F} can also be set. The switching of the directional control valves 48, 55 is performed following the input of the command “position” in the correct sequence from the “position pressure P_{A}” to “fixing pressure P_{F}”. For this purpose, the electromagnets of the directional control valves 48, 55 are connected via the connectors 52(68) and 52(67) and electrical control lines 67, or 68. The actual value output 81 is connected via an electrical connecting line 81 and a connector 52(81) with the control device 52, and the reference variable input 82 is connected via an electrical connecting line 54 and a connector (52/82) with the control device. The voltage supply 56 of the control unit 52 takes place via its connector 52(56). A sufficient number of displays of the set reference pressure and the actual pressure are provided at the machine control console.

Furthermore, prior to the automatic application of the fixing pressure P_{F}, the drive mechanism 39 is charged in such a way that the detent 32 rests against its associated stop face 31, or 42, or 20, and that it switches off when a preselected torque or motor current, for example, has been reached. The drive mechanism 39 can be regulated to run in the right or left direction by the control device 52 via the electrical feed line 41. Because of this the release of the blockage of the base plate 52 when adjusting the positioning force F_{A}, or after the command “roller off”, can be performed.

It lies within the scope of the invention that for generating the positioning force F_{A} it is not limited to pneumatic or hydraulic drive mechanisms 24. Piezo-electrical or electrochemical operating devices are also suitable. As represented in FIG. 3, the top 42 of the base plate 25 is used as an abutment, and the underside 83 of the set plate 09 as the force application point for the operating device 94. For its control, the operating device 94 is connected via an electrical connecting line 61 with the control device 52.

A pressure measuring arrangement 84 with its electrical connector 85 is arranged on the set plate 09 for the purpose of actually measuring the positioning force F_{A} exerted by the operating device 94. It is used for measuring the actual value of F_{A}. The pressure measuring arrangement 84 can consist, for example, of strain gauge strips in a Wheaton bridge circuit. In this case the branches of the bridge are then placed on the top 20 and the underside 83 of the set plate 09 in the vicinity of the shaft receiver 03. Blocking and unblocking of the set plate 09 by means of a detent 32 takes place as described above in the other exemplary embodiments.

We repeat that, in case of an over-mounted seating, a device 26 for adjusting the pressure force F_{A}, or fixing force F_{F} per roller 02 to be positioned per bearing journal, or bearing shaft 06, is provided. If the positionable roller 02 is not seated over-mounted, two devices 26 are provided, which can be selectively preset and/or switched in singly or together, so that they act on one or both shaft receivers 06 per roller 02.

List of Reference Numerals

01 Roller, cylinder

02 Roller, cylinder

03 Shaft receiver, journal receiver

04 Screw (03)

05 Housing (27)

06 Bearing shaft, bearing journal (02)

07 Indentation depth

08 Machine frame

09 Set plate

10 Bore (09)

11 Guide bore (09)

12 Guide rods (25)

13 Shell (01, 02), not compressed

14 Support elbow

15 End (29)

16 Leg, vertical

17 Device for fixing

18 Ratchet screw (17)

19 Threaded part (18)

20 Top (09), pointing in the positioning direction E

21 Interior screw thread (23)

22 Adjustment head (23)

23 Eccentric bushing

24 Drive mechanism, operating device, servo cylinder, motor for linear movement, motor for rotary movement

24(2) Piston chamber connector (24)

24(4) Piston rod chamber connector (24)

25 Base plate, leg, horizontal (16)

26 Device for adjusting

27 Work cylinder, double-acting

28 Piston (27)

29 Piston rod

30 Shaft, smooth (18)

31 Underside (25), stop face, counter-bearing (32), side (25) facing away from the positioning direction (E)

32 Detent, adjusting nut, height-adjustable

33 Rod (09)

34 Line, pneumatic, hydraulic (51)

35 Distance (25-09)

36 Gear wheel, teeth

37 Driving gear wheel (39)

38 Driveshaft

39 Drive mechanism, motor for rotary movement, operating device

40 Bore (25)

41 Feed line, electr., for right-hand, left-hand running

42 Top (25), pointing in the positioning direction E

43 Distance (32)

44 Exterior screw thread (33, 34)

45 End, free (33)

46 Line, pneumatic, hydraulic (49)

47 Line, pneumatic, hydraulic (51)

48 Directional control valve 5/2-way, first, pressure valve, positioning valve

48(1) Exhaust line connector

48(2) Pressure line connector

48(3) Exhaust line connector

48(4) Work line connector

48(5) Exhaust line connector

49 Distributor, second

49(1) Feed line connector

49(2) Branch connector, first (49)

49(3) Branch connector, second (49)

50 Piston rod side (27)

51 Distributor, first, pneumatic, hydraulic

51(1) Feed line connector

51(2) Branch connector, first

51(3) Branch connector, second

52 Control device, electronic, central

52(41) Connector, electric

52(56) Connector, electric

52(68) Connector, electric

52(81) Connector, electric

52(82) Connector, electric

53 Connecting line, electrical (81>52(81)

54 Connecting line, electrical (82>52(82)

55 Directional control valve 5/2-way, second

55(1) Work line connector

55(2) Pressure line connector

55(3) Work line connector

55(4) Pressure line connector

55(5) Work line connector

56 Voltage supply (52)

57 Connector (65)

58 Connector

59 Feed line, voltage supply

60 Line, pneumatic, hydraulic

61 Control connector, electr. (94)

62 Line, pneumatic, hydraulic (49)

63

64 Pressure feed line

65 Exhaust line, first

66 Exhaust line, second

67 Control line, electrical

68 Control line, electrical

69 Closure (55(5)

70 Line, pneumatic, hydraulic

71 Closure (55(1)

72 Work line (P_{F})

73 Work line (P_{A})

74

75 Line, pneumatic, hydraulic

76 Ratchet screw

77

78 Fluid, pressure valve, electro-pneumatic

79 Fluid, pressure source

80

81 Actual value output

82 Reference variable output

83 Underside (09)

84 Pressure or force measuring arrangement

85 Connecting line (84, 52)

86 Pressure sensors, piezo-resistive

87 Regulator

88 U/I converter

89 Proportional magnet

90 Directional control valve, 3/3-way

90(A) Connector

90(P1) Connector

91

92 Branching

92(1) Connector (79)

92(2) Connector (72)

92(3) Connector (90(P1)

93 Flattening (13), positioning

94 Operating device

95 Lift (02)

96 Shell (13), compressed

97

98

E Positioning direction

E Eccentricity

F_{A} Positioning force

F_{F} Fixing force, blocking force, holding force

P_{A} Position pressure/-force

P_{F} Holding pressure/-force

P_{B} Operating positioning pressure

b36 Tooth width of the gear wheel 36

b37 Tooth width of the gear wheel 37

1. A method for adjusting a roller (02) of a printing press with the following steps:
the roller (02) is placed against at least one further roller (01) by means of a positioning force,
subsequently a detent (32), which limits the positioning path of the roller (02), is placed against the roller (02) or a receiver (03) of the roller (02).

2. The method in accordance with claim 1, characterized in that at first the detent (32) and the roller (02), or the receiver (03) of a roller (02), are put at a distance (43).

3. The method in accordance with claim 1, characterized in that a follow-up of the detent (32) is performed until it comes into contact with a counter-bearing (31, 42) supported on the machine frame (08).

4. The method in accordance with claim 1, characterized in that finally a fixing force is introduced into the receiver (03), so that the detent (32) and the counter-bearing (31, 42) rest firmly against each other.

5. The method in accordance with claim 1, characterized in that the size of the positioning force is preset.

6. A device for adjusting a roller (02) of a printing press, having an operating device (24, 94) for generating a positioning force and/or move-away force, and with an adjustable detent (32) for limiting the positioning (93) of the roller (02), characterized in that a motor (24, 39) is arranged for displacing the detent (32).

7. The device in accordance with claim 6, characterized in that the positioning force of the roller (02) is greater, at least during the positioning process, than the counter-force of the detent (32) because of the motor (24, 39).

8. The device in accordance with claim 6, characterized in that the operating device (24, 94) for generating the positioning force is an electrically or pneumatically or hydraulically driven motor for linear movements with reversal of the movement.

9. The device in accordance with claim 6, characterized in that the operating device (24, 94) for generating the positioning force is a pneumatic or hydraulic cylinder or linear motor, or a piezo-electric operating device or electro-chemical operating device with reversal of the movement.

10. The device in accordance with claim 6, characterized in that the operating device (24, 94) for generating the positioning force is an electrically or pneumatically or hydraulically driven motor (24, 39) for rotary movement, whose direction of rotation can be reversed.

11. The device in accordance with claim 10, characterized in that the force (F) to be supplied by the motor (24, 39) can be adjusted.

12. The device in accordance with claim 10, characterized in that the torque or output which can respectively be provided by the motor (24, 39) can be preset and/or limited.

13. A device for adjusting a roller (02) of a printing press by means of an operating device (24, 94), wherein the operating device (24, 94) charges the roller (02) with a first force during production, characterized in that during positioning of the roller (02) the operating device (24, 94) charges the latter with a second force.

14. The device in accordance with claim 13, characterized in that the force during production is greater than the force during positioning.

15. The device in accordance with claims 6 or 13, characterized in that a receiver (03) for bearing journals (06) of the roller (02) is arranged, and that a set plate (09), which is movable in and opposite to the positioning direction (E) of the roller (02) to be positioned, and has an arrangement for seating and/or fastening a bearing shaft or bearing journal (06) of the roller (02), is provided as the receiver (03).

16. The device in accordance with claim 15, characterized in that after reaching its contact position (93), the receiver (03, 09, 20) has a detent (32), which can be directly or indirectly brought into contact with the set plate (09) pointing in the positioning direction (E) and which is directly or indirectly supported on a base plate (25, 14).

17. The device in accordance with claim 16, characterized in that the detent (32) is rotatable.

18. The device in accordance with claim 13, characterized in that the operating devices (24) and/or (94) are servo cylinders (24), which can be charged with a hydraulic fluid, or piezo-electric operating devices or electrochemical operating device (94).

19. The device in accordance with claim 18, characterized in that an electro-pneumatic pressure regulating valve (78) is provided for the supply with hydraulic fluid of the servo cylinder (24), which can be charged with hydraulic fluid.

20. The device in accordance with claim 19, characterized in that a first controllable direction control valve (48) is provided for regulating the servo cylinder (24).

21. The device in accordance with claim 20, characterized in that the directional control valve is a 5/2-way directional control valve.

22. The device in accordance with claim 20, characterized in that a second switchable directional control valve (55) is provided, while interposing the first directional control valve (48), for supplying the servo cylinder (24) with hydraulic fluid of different pressures (P_{A}, P_{F}, P_{B}) from the electro-pneumatic pressure control valve (78), or from a fluid pressure source (79).

23. The device in accordance with claims 20 and 22, characterized in that an electronic control device is provided for the sequentially correct control of the operating devices (24, 39, 94) of the electro-hydraulic pressure control valve (78), the directional control valves (48, 55) and a force or pressure measuring device (84, 85).
